(19) United States
(12) Patent Application Publication
(10) Pub. No.: US 2026/0132817 A1
(43) Pub. Date: May 14, 2026

(54) BEARINGS HAVING ASYMMETRICAL RECESSES

(71) Applicant: Schlumberger Technology Corporation, Sugar Land, TX (US)

(72) Inventors: Arthur Ignatius Watson, Houston, TX (US); Pradeep Mahadevan, Singapore (SG); Alejandro Camacho Cardenas, Houston, TX (US)

(21) Appl. No.: 19/348,650

(22) Filed: Oct. 2, 2025

Related U.S. Application Data
(60) Provisional application No. 63/702,509, filed on Oct. 2, 2024.

(51) Int. Cl. F16C 32/06

(52) U.S. Cl. CPC F16C 32/0659; F16C 2352/00

(57) ABSTRACT

A bearing may include a body defining a bore having an inner surface, the inner surface including a bearing surface. A bearing may include a plurality of recesses inset in the inner surface, wherein the plurality of recesses are asymmetrical, the plurality of recesses configured to generate a non-rotating net radial force on the journal.

### CROSS-REFERENCE TO RELATED APPLICATIONS

The present application claims the benefit of U.S. Provisional Application No. 63/702,509 filed Oct. 2, 2024, the entirety of which is incorporated by reference herein and should be considered part of this specification.

### BACKGROUND OF THE DISCLOSURE

Bearings are used in many applications to decrease friction and improve the operating lifetime of rotating components. Bearings may be hydrostatic, in which the bearing is a closed system, and the oil may be pressurized from an external source. Some bearings may be hydrodynamic bearings, in which oil is pressurized based on rotation of a journal within the bearing.

Bearings may be used in any mechanical or rotating structure. For example, bearings may be pumps, motors, engines, wheels, and so forth. In one situation, a bearing may be used to support the moving parts of an electric submersible pump (ESP). ESPs may be used to pump fluid out of a wellbore. For example, in an oil and gas wellbore, ESPs may be used to pump water and/or hydrocarbons out of the wellbore. The rotating parts of an ESP may rotate with a high rotational rate, including rates up to and greater than 10,000 rotations per minute (RPM).

### SUMMARY

In some aspects, the techniques described herein relate to a bearing supporting rotation of a journal. The bearing includes a body defining a bore having an inner surface. The inner surface includes a low-friction bearing surface that may comprise a low-friction coating. A plurality of recesses such as grooves are inset in the inner surface. The plurality of recesses are asymmetrical. Alternatively, contours, for example of ends, of the bearing may be asymmetric. The plurality of recesses or the contours are configured to generate a non-rotating net radial force on the journal.

In some aspects, the techniques described herein relate to a bearing system. The bearing system includes a body defining a bore having an inner surface. A plurality of recesses is inset in the inner surface. The plurality of recesses have an asymmetrical arrangement. A journal is inserted in the bore and configured to rotate in the bore. A fluid such as oil is located between the journal and the body. The plurality of recesses apply a force on the journal based on the asymmetrical arrangement.

In some aspects, the techniques described herein relate to a method for operating a bearing. A journal is received in a bore. The bore is defined by an inner surface of a body. The inner surface is coated with a low-friction coating. A plurality of recesses is inset in the inner surface. The plurality of recesses has an asymmetrical arrangement. The bore includes oil between the journal and the inner surface. The journal is rotated in the bore causing an oil film of the oil to develop between the journal and the inner surface. A non-rotating net radial force is generated on the journal based on the asymmetrical arrangement of the plurality of recesses.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a perspective view of a schematic representation of a bearing system 100, according to at least one embodiment of the present disclosure.

FIG. 2 is a cross-sectional view of a representation of a bearing system, according to at least one embodiment of the present disclosure.

FIG. 3 is a cross-sectional view of a representation of a bearing, according to at least one embodiment of the present disclosure.

FIG. 4 is a cross-sectional view of a representation of a bearing, according to at least one embodiment of the present disclosure.

FIG. 5 is a cross-sectional view of a representation of a bearing, according to at least one embodiment of the present disclosure.

FIG. 6-1 and FIG. 6-2 are representations of cross-sectional views of a bearing, according to at least one embodiment of the present disclosure.

FIG. 7 is a longitudinal cross-sectional view of a representation of a bearing, according to at least one embodiment of the present disclosure.

FIG. 8 is a longitudinal cross-sectional view of a representation of a bearing, according to at least one embodiment of the present disclosure.

FIG. 9 is a longitudinal cross-sectional view of a representation of a bearing, according to at least one embodiment of the present disclosure.

FIG. 10-1 and FIG. 10-2 are representations of cross-sectional views of a bearing, according to at least one embodiment of the present disclosure.

FIG. 11 is a longitudinal cross-sectional view of a representation of a bearing, according to at least one embodiment of the present disclosure.

FIG. 12 is a cross-sectional view of a representation of a bearing, according to at least one embodiment of the present disclosure.

FIG. 13 is a flowchart of a method for operating a bearing, according to at least one embodiment of the present disclosure.

### DETAILED DESCRIPTION

This disclosure generally relates to devices, systems, and methods for radial bearings having asymmetric recesses to apply a differential pressure to a journal within the bearing. In some situations, a bearing may be subject to oil whirl, in which a slug of oil is generated by rotation of the journal. For example, friction between the journal and the oil may cause the oil to spin within the bearing. But the bearing may not rotate, and the differential friction experienced by the oil may result in the buildup of a plug of oil, or a portion of the oil film that has a greater thickness and may apply a force to the journal. This may result in eccentric rotation of the journal. The eccentric rotation of the journal may cause vibration of the journal in the bearing, the buildup of which may result in damage to the bearing and/or the structure in which the bearing is housed. This may cause failure of the bearing and/or the associated structure.

Conventionally, oil whirl is mitigated through deliberate misalignment or eccentricity of bearings, which may stably load the bearings, thereby reducing the oil whirl. But in some situations, such as in ESPs, it is not practical to deliberately load the bearing. Further, conventional systems may include radial holes with hydrostatic pressure, steps or dams, tilting pads, lobed bearings, and bearing pads whose radius is eccentric with the bearing. But such systems are bulky, subject to reduced performance based on wear, and may not be practical in a space-limited environment and/or may be overly expensive.

In accordance with at least one embodiment of the present disclosure, a bearing may include multiple oil channels or contours in the inner surface of the bearing that are asymmetric. The asymmetric channels may to induce a non-rotating net radial force on the journal that reduces the oil film thickness on the opposite side. This non-rotating net radial force may channel oil axially or radially through the channels or contours, rather than permitting it to whirl circumferentially and deflect the journal. The non-rotating net radial force, caused by the reduced oil thickness may stabilize the rotor and reduce half frequency oil whirl vibration. This may result in reduced damage to the bearing and/or surrounding structure (such as an ESP or other structure).

As illustrated by the foregoing discussion, the present disclosure utilizes a variety of terms to describe features and advantages of the bearing system. Additional detail is now provided regarding the meaning of such terms. For example, as used herein, the term “bearing” refers to a stationary element in a bearing system. In particular, the term “bearing” can include an element that is formed integral in a part. A bearing may be formed by a cylindrical bushing inserted into a part. The bearing may be coated with a low-friction coating to facilitate rotation.

As used herein, a “journal” may refer to the rotating element of a bearing. For example, a journal may be a shaft inserted into the bore formed by the inner surface of the cylinder of the bearing. The journal may be connected to one or more rotating parts of a structure. The journal may be a tubular sleeve that is fixed to the shaft, the sleeve rotating with the shaft inside the bearing, presenting superior bearing characteristics to the bearing, and preventing wear of the shaft. The journal may rotate with a high rotational rate, including up to and over 10,000 RPM.

As used herein, “asymmetrical,” and other forms thereof, may refer to variability about at least one axis. For example, asymmetrical may refer to variability with respect to circumferential position. In some examples, asymmetrical may refer to variability with respect to longitudinal position. In some examples, asymmetrical may refer to variability with respect to radial depth. In some examples, asymmetry may refer to variability with respect to one element or recess. In some examples, asymmetry may refer to variability across multiple elements or recesses.

As used herein, a “low-friction coating” may be a coating on the inner surface of a bearing that has a low coefficient of friction. For example, the bearings of the present disclosure may be thin-walled bearings having a low-friction coating on the thin-walled bearing. A non-limiting example of a thin-walled bearing having the low-friction coating may be the DP4® bearing from GGB®, although other thin-walled bearings having a low-friction coating may be used in association with the techniques described herein.

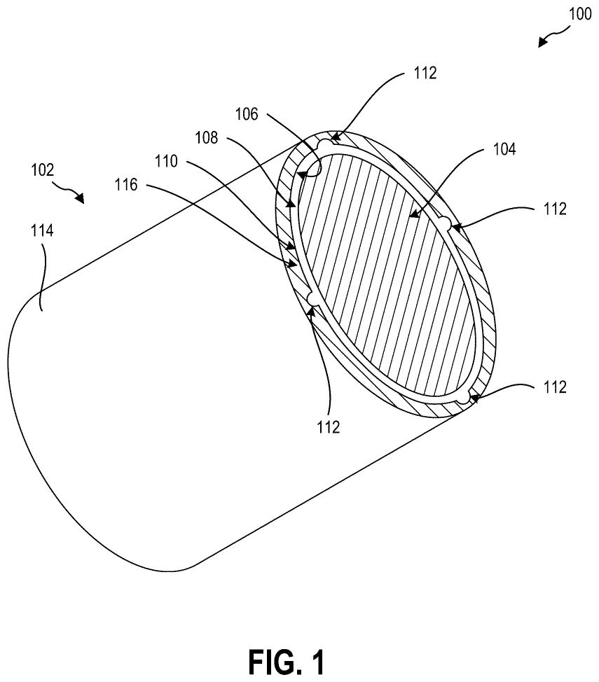

FIG. 1 is a perspective view of a schematic representation of a bearing system 100, according to at least one embodiment of the present disclosure. The bearing system 100 includes a bearing 102 and a journal 104, the bearing 102 supporting rotation of the journal 104. The bearing 102 includes a body 114, the body 114 forming a bore 116 therethrough. The journal 104 is inserted into the bore 116. The bore 116 is defined by an inner surface 106, and the journal 104 has an outer surface 108. An annular space 110 between the inner surface 106 of the bearing 102 and the outer surface 108 of the journal 104 may be filled with oil or grease.

As discussed herein, during rotation of the journal 104 with respect to the bearing 102, the oil within the annular space 110 may form an oil film. The oil film may prevent contact between the journal 104 and the bearing 102, thereby lubricating and facilitating easy rotation between the bearing 102 and the journal 104. In some situations, as discussed herein, the oil film may develop an oil plug in the annular space 110. The oil plug may rotate about the annular space 110, thereby causing potentially damaging vibrations in the bearing system 100. An oil plug may include a thicker film of oil that encompasses a portion of the circumference of the bearing space, tending to displace or maintain the journal toward the opposite side of the axis.

In accordance with at least one embodiment of the present disclosure, the bearing 102 may include one or more recesses 112 inset in the inner surface 106 of the bearing 102. The recesses 112 may be any type of recess, such as a groove, a recess, a contour in the surface of the bearing 102, any other recesses 112, and combinations thereof. The recesses 112 may be asymmetrical. Asymmetrical recesses may apply a non-rotating net radial force on the journal 104, pushing the outer surface 108 of the journal 104 closer to one portion of the inner surface 106 of the bearing 102, reducing the distance between the outer surface 108 and the inner surface 106 in the annular space 110. When the oil film encounters the reduced distance between the outer surface 108 and the inner surface 106 in the annular space 110, the non-rotating net radial force may push at least a portion of the oil through one or more of the recesses 112. This may, in accordance with at least one embodiment, prevent the buildup of an oil plug, reduce the severity of any oil plugs generated within the annular space 110, or break up an existing oil plug within the annular space 110. In this manner, the asymmetrical recesses 112 may, in accordance with at least one embodiment, reduce or prevent damage to the bearing system 100 due to vibrations caused by oil whirl.

As discussed in further detail herein, the recesses 112 may be asymmetrical in any manner. For example, the recesses 112 may be asymmetrically arranged about the circumference of the inner surface 106. In some examples, one or more of the recesses 112 may be asymmetrical along the length of the bearing 102, including in circumferential position, radial depth, or otherwise asymmetrical along the length of the bearing 102. In some examples, two or more of the recesses 112 may be asymmetrical with respect to shape. In some examples, the bearing 102 may include different types of recesses 112 along the length of the bearing 102.

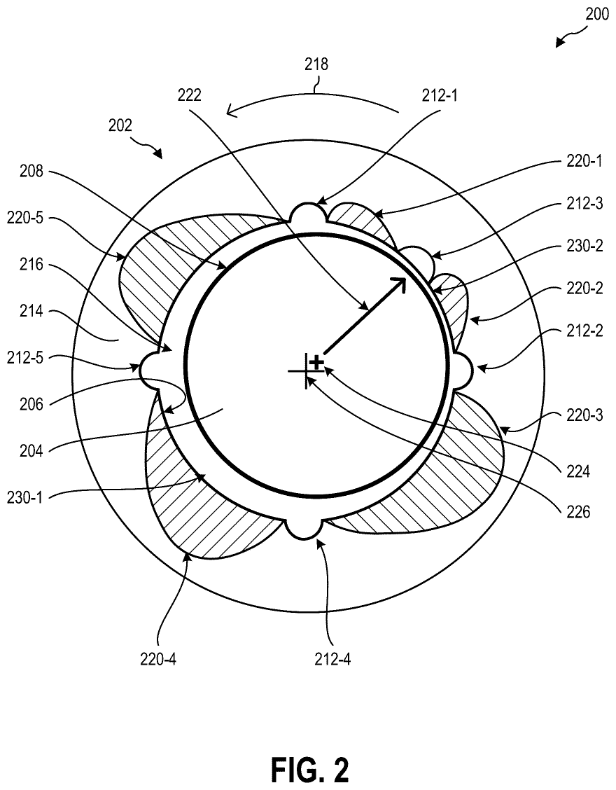

FIG. 2 is a cross-sectional view of a representation of a bearing system 200, according to at least one embodiment of the present disclosure. The bearing system 200 includes a bearing 202. A body 214 of the bearing 202 includes an inner surface 206 that defines a bore 216. A journal 204 is inserted into the bore 216, and the bearing supports rotation of the journal 204. The body 214 includes a plurality of recesses (collectively 212) inset in the inner surface 206.

The recesses 212 are asymmetrical. For example, in the embodiment shown, the recesses 212 are unevenly spaced around a circumference of the inner surface 206 of the bearing 202. Put another way, there is a different arc length between two or more recesses 212 along the inner surface 206. For example, in the embodiment shown, a first recess 212-1 first recess is located at 0° (e.g., straight up in the view shown), a second recess 212-2 is located at 90°, and a third recess 212-3 is located between the first recess 212-1 first recess and the second recess 212-2 at 45°. A fourth recess 212-4 is located at 180°, and a fifth recess 212-5 is located at 270°.

The arrangement shown results in an arc length of 45° between the first recess 212-1 first recess and the third recess 212-3, an arc length of 45° between the third recess 212-3 and the fourth recess 212-4, an arc length of 90° between the second recess 212-2 and the fourth recess 212-4, and an arc length of 90° between the fourth recess 212-4 and the fifth recess 212-5. The pressure generated by the oil due to rotation of the journal 204 (when the journal 204 is rotated in a rotational direction 218, the counter-clockwise direction) is illustrated by the pressure profiles (collectively 220). It should be noted that the pressure profiles 220 are schematic, and that the actual pressure profiles and ratios between pressures and pressure profiles may vary than those shown based on the specific operating conditions and geometries of the bearing system 200.

In the embodiment shown, a first pressure profile 220-1 is illustrated between the first recess 212-1 first recess and the third recess 212-3, a second pressure profile 220-2 is illustrated between the third recess 212-3 and the second recess 212-2, a third pressure profile 220-3 is illustrated between the second recess 212-2 and the fourth recess 212-4, a fourth pressure profile 220-4 is illustrated between the fourth recess 212-4 and the fifth recess 212-5, and a fifth pressure profile 220-5 is illustrated between the fifth recess 212-5 and the first recess 212-1 first recess. The magnitude of the force generated by the oil may be based on the arc length between two adjacent recesses 212. In the embodiment shown, the third pressure profile 220-3, the fourth pressure profile 220-4, and the fifth pressure profile 220-5 illustrate the same pressure profile, based on the same arc length between the second recess 212-2 and the fourth recess 212-4, the fourth recess 212-4 and the fifth recess 212-5, and the fifth recess 212-5 and the first recess 212-1 first recess. As may be seen, the reduced arc length between the first recess 212-1 first recess and the third recess 212-3, and between the third recess 212-3 and the second recess 212-2 may cause a reduced pressure profile at the first pressure profile 220-1 and the second pressure profile 220-2. This may result in, during rotation of the journal 204, a non-rotating net radial force 222 toward the first pressure profile 220-1 and the second pressure profile 220-2 applied to the journal 204.

The journal 204 rotates about a journal rotational axis 224. In accordance with at least one embodiment of the present disclosure, when the journal 204 rotates in the bearing 202, the non-rotating net radial force 222 may cause the rotational axis 224 to be offset from a bore central axis 226 of the bore 216. Offsetting the journal rotational axis 224 from the bore central axis 226 may cause the annular space or thickness between the inner surface 206 and the outer surface 208 of the journal 204 to be different in a first annular zone 230-1 and a second annular zone 230-2. For example, the first annular zone 230-1 may be adjacent the fourth pressure profile 220-4 and the fifth pressure profile 220-5, and the second annular zone 230-2 may be adjacent the first pressure profile 220-1 and the second pressure profile 220-2. The second annular zone 230-2 may have a smaller thickness between the outer surface 208 and the inner surface 206 than the first annular zone 230-1. This may force oil away from the journal 204. For example, pushing the journal 204 in the direction of the non-rotating net radial force 222 may force oil radially toward the first annular zone 230-1 and/or axially through the third recess 212-3, the first recess 212-1 first recess, and/or the second recess 212-2. This may reduce or prevent the formation of plugs of oil, thereby reducing or preventing oil whirl and improving stability of the bearing system 200.

While a specific arrangement of five recesses 212 with a particular spacing is illustrated, this disclosure is not so limited. Indeed, bearing systems of the present disclosure may include any number of grooves, including 2, 3, 4, 5, 6, 7, 8, 9, 10, or more grooves. Furthermore, bearing systems of the present disclosure may include any variation in the asymmetry in arc length between recesses 212, resulting in different directions and magnitudes of the non-rotating net radial force 222, as well as different offsets between the journal rotational axis 224 and the bore central axis 226.

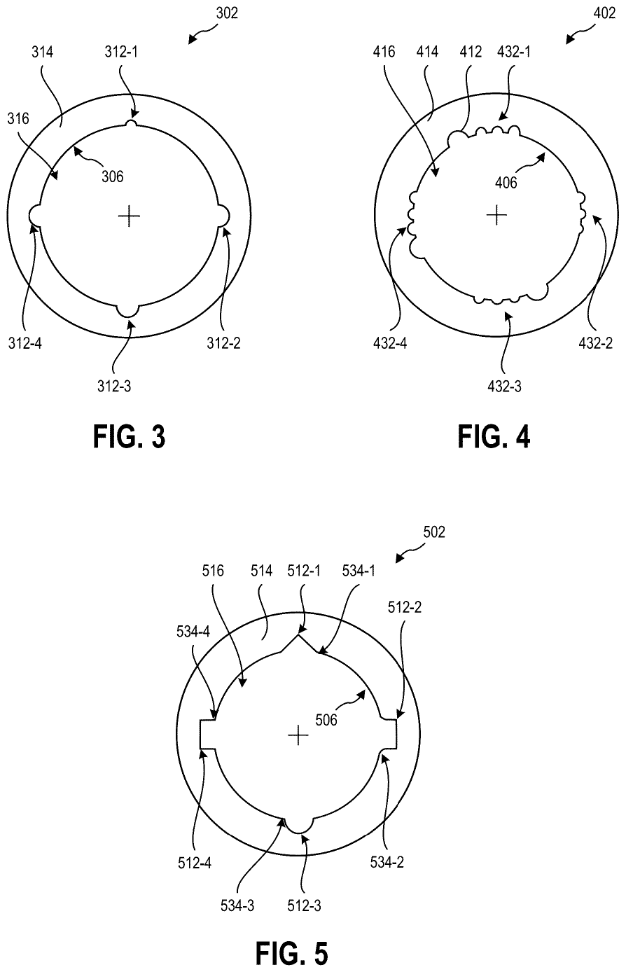

FIG. 3 is a cross-sectional view of a representation of a bearing 302, according to at least one embodiment of the present disclosure. The bearing 302 includes a body 314 having an inner surface 306 that defines a bore 316. A journal may be inserted the bore 316 and the bearing 302 may support rotation of the journal. The body 314 includes a plurality of recesses (collectively 312) inset in the inner surface 306.

In the embodiment shown, the recesses 312 may have an asymmetrical arrangement such that at least one of the recesses 312 has a different size than another of the recesses 312. For example, the bearing 302 includes a first recess 312-1, a second recess 312-2, a third recess 312-3, and a fourth recess 312-4. The first recess 312-1 illustrated is smaller than the second recess 312-2, the third recess 312-3, and the fourth recess 312-4. Put another way, the recesses 312 have unequal cross section, including an unequal depth and/or an unequal width of the recesses 312. The cross section of the recesses 312 may influence how much of the oil exiting one sector is carried over into the next sector or escapes through the oil recesses. The differential cross section may further influence the supply of oil to the next sector from axially outside the bearing. This may, in accordance with at least one embodiment, result in a greater pressure profile in some sectors of the bore 316 that may bias the journal toward the opposite side.

FIG. 4 is a cross-sectional view of a representation of a bearing 402, according to at least one embodiment of the present disclosure. The bearing 402 includes a body 414 having an inner surface 406 that defines a bore 416. A journal may be inserted the bore 416 and the bearing 402 may support rotation of the journal. The body 414 includes a plurality of recesses 412 inset in the inner surface 406. The recesses 412 may be arranged in recess groups (collectively 432).

For example, the recesses 412 may be arranged with a first recess group 432-1, a second recess group 432-2, a third recess group 432-3, and a fourth recess group 432-4. The recess groups 432 may create greater pressure drop of oil circulating across them. This may increase the amount of oil escaping the bearing axially through the recesses 412 rather than crossing the recesses 412 to the next sector. Different recesses 412 in a recess group 432 may have different cross sections. For example, at the trailing edge of one recess group 432 there may be multiple small recesses 412 to increase pressure drop, but the last recess 412 before the next sector may be larger to supply that sector with sufficient oil from axially outside the bushing. In this manner, the recesses 412 within a single recess group 432 may be asymmetrical.

The composition of recesses 412 within different recess groups 432 may be asymmetrical. For example, the first recess group 432-1, third recess group 432-3 and fourth recess group 432-4 have a large and three smaller recesses 412 and the second recess group 432-2 has three smaller recesses 412. The difference in the composition of the recess groups 432 may result in a non-rotating net radial force within the bearing 402 based on the change in composition.

FIG. 5 is a cross-sectional view of a representation of a bearing 502, according to at least one embodiment of the present disclosure. The bearing 502 includes a body 514 having an inner surface 506 that defines a bore 516. A journal may be inserted the bore 516 and the bearing 502 may support rotation of the journal. The body 514 includes a plurality of recesses (collectively 512) inset in the inner surface 506. The recesses 512 are asymmetrical, or asymmetrically arranged.

In accordance with at least one embodiment of the present disclosure, the recesses 512 may have different shapes. For example, the bearing 502 includes a first recess 512-1, a second recess 512-2, a third recess 512-3, and a fourth recess 512-4. The first recess 512-1 has a first shape that is pointed, the second recess 512-2 and the fourth recess 512-4 have a second shape that is rectangular, and the third recess 512-3 has a third shape that is semi-circular. The different shapes may result in different pressure profiles, which may cause a non-rotating net radial force within the bearing 502.

The recesses 512 have a transition (collectively 534) between the surface of the recesses 512 and the inner surface 506 of the body 514. The transition 534 may alter the engagement of the oil with the inner surface 506 at the recesses 512. The transition 534 may change the pressure profile at a particular groove, which may cause and/or alter a non-rotating net radial force within the bearing 502.

For example, the first recess 512-1 includes a first transition 534-1, the second recess 512-2 includes a second transition 534-2, the third recess 512-3 includes a third transition 534-3, and the fourth recess 512-4 includes a fourth transition 534-4. As may be seen, the third transition 534-3 and the fourth transition 534-4 have a sharp transition, which may be 90° to a tangent of the inner surface 506 at the fourth transition 534-4. The first transition 534-1 has a larger angle, which may reduce turbulent flow of oil at the first transition 534-1. The second transition 534-2 has a rounded shape, which may reduce the turbulent flow of oil at the second transition 534-2. Each of the transitions 534 may generate a different oil pattern at its respective recesses 512, thereby changing the pressure profile at the recesses 512. Asymmetry between the transition 534 may result in a non-rotating net radial force within the bearing 502.

The shape of the recesses 512, and the associated transitions 534 with the inner surface 506 may be any shape, size, radius, angle, step, or other variation in the recesses 512 and/or transitions 534. In some embodiments, the leading edge of a recess 512 (e.g., the edge encountered first during rotation of the journal) may have the same transition 534 than the transition 534 at the trailing edge of the recess 512. In some embodiments, the leading edge of a recess 512 (e.g., the edge encountered first during rotation of the journal) may have a different transition 534 than the transition 534 at the trailing edge of the recess 512. This may change the pressure profile and the associated non-rotating net radial force within the bearing 502.

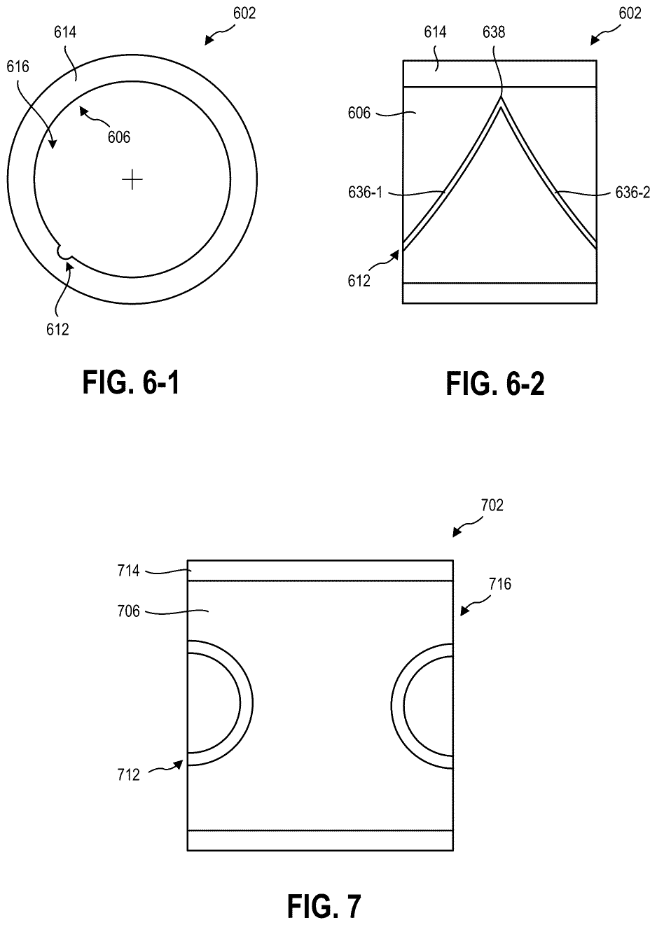

FIG. 6-1 is a radial cross-sectional view of a representation of a bearing 602, according to at least one embodiment of the present disclosure. The bearing 602 includes a body 614 having an inner surface 606 that defines a bore 616. A journal may be inserted the bore 616 and the bearing 602 may support rotation of the journal. The body 614 includes a recess 612 612 inset in the inner surface 606.

FIG. 6-2 is a longitudinal cross-sectional view of the bearing 602 of FIG. 6-1. As may be seen in FIG. 6-2, the recess 612 612 is asymmetrical along a length of the bearing 602. For example, the recess 612 612 may change circumferential position along the longitudinal length of the bearing 602. The recess 612 612 may direct oil toward a specific location or in a specific direction (e.g., into or out of a region). Such recesses 612 may comprise a first recess segment 636-1 and a second recess segment 636-2 that intersect to form a chevron or “V” at an apex 638. The apex 638 of the chevron may be pointed into the flow from the trailing edge of a bearing sector to redirect oil axially out of the bearing 602. This may reduce oil flowing into the next sector, and inhibit oil whirl. The apex 638 may be pointed in the same direction as the flow to catch oil and force more into the leading edge of the next sector and increase fluid pressure. The angle at the apex 638 may be selected to adjust the pressure profile and the associated non-rotating net radial force within the bearing 602. Chevrons of opposite orientation may be combined to form a diamond or an “X” pattern in an asymmetric arrangement to create a non-rotating net radial force.

The recess 612 612 may have any shape along the inner surface 606. For example, the recess 612 612 may have a straight shape, a curved shape, a step-wise shape, any other shape, and combinations thereof.

FIG. 7 is a longitudinal cross-sectional view of a representation of a bearing 702, according to at least one embodiment of the present disclosure. The bearing 702 includes a body 714 having an inner surface 706 that defines a bore 716. A journal may be inserted the bore 716 and the bearing 702 may support rotation of the journal. The body 714 includes recesses 712 inset in the inner surface 706.

In the embodiment shown, the recesses 712 are asymmetrical across the inner surface 706. For example, a recess 712 may curve back on itself along the length of the inner surface 706. The orientation of the recesses 712 may direct oil to or away from particular locations within the bearing 702. For example, the recesses 712 shown may direct oil away from the central region of the bore 716, thereby reducing the pressure and reducing or preventing oil whirl.

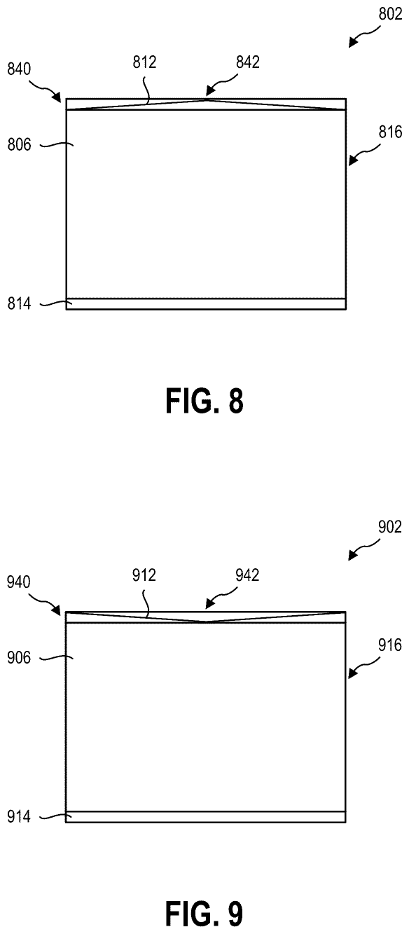

FIG. 8 is a longitudinal cross-sectional view of a representation of a bearing 802, according to at least one embodiment of the present disclosure. The bearing 802 includes a body 814 having an inner surface 806 that defines a bore 816. A journal may be inserted the bore 816 and the bearing 802 may support rotation of the journal. The body 814 includes a recess 812 inset in the inner surface 806.

In the embodiment shown, the recess 812 is asymmetrical in depth along the length of the bearing 802. For example, the recess 812 is shallower at the edges 840 of the body 814 and deeper at a center 842 of the body 814. The change in depth along the recess 812 may adjust the oil buildup and pressure profile along the length of the bearing 802. For example, when the recess 812 is deeper at the center 842 of the body 814, the recess 812 may cause a buildup of pressure at the center 842, thereby applying a non-rotating net radial force on the journal.

FIG. 9 is a longitudinal cross-sectional view of a representation of a bearing 902, according to at least one embodiment of the present disclosure. The bearing 902 includes a body 914 having an inner surface 906 that defines a bore 916. A journal may be inserted the bore 916 and the bearing 902 may support rotation of the journal. The body 914 includes a recess 912 inset in the inner surface 906.

In the embodiment shown, the recess 912 is asymmetrical in depth along the length of the bearing 902. For example, the recess 912 is shallower at the center 942 of the body 914 and deeper at the edges 940 of the body 914. The change in depth along the recess 912 may adjust the oil buildup and pressure profile along the length of the bearing 902. For example, when the recess 912 is deeper at the edges 940 of the body 914, the recess 912 may cause a reduction in pressure at the center 942 and an escape of pressure at the edges 940, thereby applying a non-rotating net radial force on the journal.

In some embodiments, the bearing 902 may include multiple recesses 912 having varying depth along the length of the bearing 902. For example, the bearing 902 may include a first recess that is deeper at the center 942 (as illustrated in FIG. 8), and a second recess 912 that is deeper at the edges 940. The first recess may be located opposite the second recess, resulting in a non-rotating net radial force to offset the position of the journal within the bore 916.

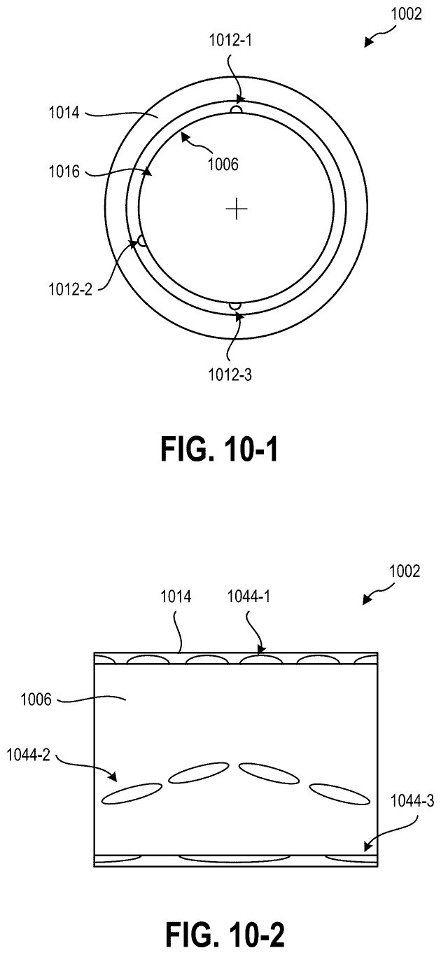

FIG. 10-1 is a radial cross-sectional view of a representation of a bearing 1002, according to at least one embodiment of the present disclosure. The bearing 1002 includes a body 1014 having an inner surface 1006 that defines a bore 1016. A journal may be inserted the bore 1016 and the bearing 1002 may support rotation of the journal. The body 1014 includes a plurality of dimples (collectively 1012) inset in the inner surface 1006. In particular, the bearing 1002 includes a first dimple 1012-1, a second dimple 1012-2, and a third dimple 1012-3.

FIG. 10-2 is a longitudinal cross-sectional view of the bearing 1002 of FIG. 10-1. As may be seen, a dimple may be a non-continuous recess, or a recess that does not extend an entirety of the length of the bearing 1002. The dimples 1012 illustrated are asymmetrical. For example, different dimples 1012 may have uneven spacing, varying depths, varying sizes, grouping, skewed lines, chevrons, curved patterns, any other asymmetrical arrangement, and combinations thereof. The dimples may have shape, such as oblong, circular, oval, polygonal, teardrop, asymmetrical, irregular, any other shape, and combinations thereof. In a thin-wall bushing, the dimple may comprise a hole through the thin wall.

In some embodiments, the dimples may be closed. For example, the dimples may not reach the end of the bearing, thus forming a valley of trapped oil pressure inside the bearing. Alternatively, dimples may be open to the end of the bearing edge, permitting oil pressure to escape. These forms may be combined asymmetrically in a bearing to bias the rotor to one side.

In the embodiment shown, the first dimple 1012-1 is part of a first dimple set 1044-1, the second dimple 1012-2 is part of a second dimple set 1044-2, and the third dimple 1012-3 is part of a third dimple set 1044-3. The first dimple set 1044-1 has dimples having a first length, the second dimple set 1044-2 has dimples of a second length, and the third dimple set 1044-3 has dimples of a third length. This asymmetrical distribution of dimple length may change the interaction of the oil with the inner surface 1006. Further, the second dimple set 1044-2 is arranged in a chevron pattern, as discussed above with respect to FIG. 6-1 and FIG. 6-2, including the associated biasing force.

FIG. 11 is a longitudinal cross-sectional view of a representation of a bearing 1102, according to at least one embodiment of the present disclosure. The bearing 1102 includes a body 1114 having an inner surface 1106 that defines a bore 1116. A journal may be inserted the bore 1116 and the bearing 1102 may support rotation of the journal.

In the embodiment shown, the bearing 1102 has a first length 1146-1 at a first side of the body 1114 and a second length 1146-2 at a second side of the body 1114. Put another way, the ends of the bearing have a contour that is not perpendicular to the axis. In the embodiment shown, the ends of the bearing 1102 are cut in a plane slanted to the axis. In some embodiments, more complex contours may be used to adjust the flow of oil along the bearing 1102. In some embodiments, the edge of the bearing 1102 having the longer second length 1146-2 may generate a greater pressure profile than edge of the bearing 1102 having the shorter first length 1146-1. The reduced pressure profile of the edge having the first length 1146-1 may be reduced based on the smaller area and higher axial leakage factor from the edges. This may result in a non-rotating net radial force toward the shorter side and inhibit oil whirl.

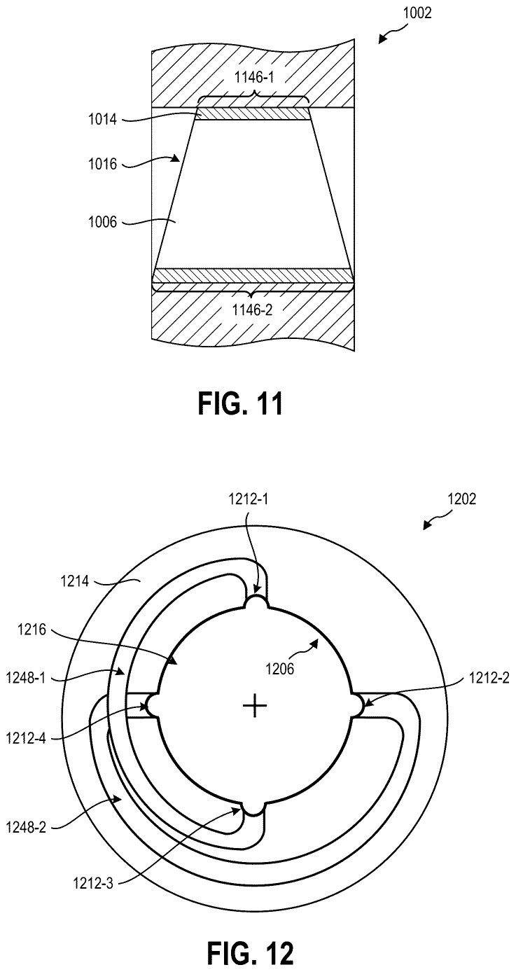

FIG. 12 is a cross-sectional view of a representation of a bearing 1202, according to at least one embodiment of the present disclosure. The bearing 1202 includes a body 1214 having an inner surface 1206 that defines a bore 1216. A journal may be inserted the bore 1216 and the bearing 1202 may support rotation of the journal. The body 1214 includes a plurality of recesses (collectively 1212) inset in the inner surface 1206.

For example, the bearing 1202 includes a first recess 1212-1, a second recess 1212-2, a third recess 1212-3, and a fourth recess 1212-4. In accordance with at least one embodiment of the present disclosure, radial holes in the recesses may communicate with a conduit (collectively 1248) on the outside of a bearing. The conduits 1258 may open at the various recesses with a conduit opening. The conduits 1248 provide a flow path from the trailing edge of one sector to the leading edge of another sector. For instance, a conduit 1248 may route an oil flow from one recess 1212, past the adjacent recess 1212 to another recess 1212. For example, a first conduit 1248-1 may connect the first recess 1212-1 to the third recess 1212-3 and a second conduit 1248-2 may connect the second recess 1212-2 to the fourth recess 1212-4. Flowing oil between the recesses 1212 may help to reduce oil whirl by improving oil flow throughout the bore 1216. In some embodiments, a conduit 1248 may connect a groove back to itself.

In some embodiments, the conduits 1248 may include recesses in the outer surface of a bushing or in the inner surface of the housing thereof. These grooves may be circumferential, axial, or skewed. Intersections and discontinuities of recesses (e.g., formed by inserted blocks or discontinuous machining) may be used to direct flow from the trailing edge of any recess 1212 or from outside the bearing to the leading edge of a targeted sector or to outside the bearing.

The spacing, number, size, angle, and shape of holes between different recesses 1212 may be varied asymmetrically to effect different pressure profiles in different sectors to produce a bias and inhibit oil whirl. For instance, holes may be angled from directly radial to produce a greater or lesser flow from the bearing anulus into the hole or to produce flow in the opposite direction.

In accordance with at least one embodiment of the present disclosure, two or more of the techniques discussed herein with respect to FIG. 2 through FIG. 12 may be combined in a single bearing. For example, various mechanisms to introduce asymmetry into the recesses of a bearing have been described herein. The different mechanisms may be combined in any manner. For example, a first asymmetry or asymmetrical arrangement may be provided in a first zone of a bearing, and a second asymmetry or asymmetrical arrangement may be provided in a second zone of a bearing.

The zones in a bearing may be any type of zone. For example, a zone may be circumferential (e.g., over a particular arc length of a bearing). In some examples, a zone may be longitudinal (e.g., over a longitudinal length of a bearing). A bearing may have any number of zones, including 1, 2, 3, 4, 5, 6, 7, 8, 9, 10, or more zones. In some embodiments, a bearing may have both circumferential zones and longitudinal zones. In some embodiments, the circumferential zones and longitudinal zones may not overlap. In some embodiments, the circumferential zones and longitudinal zones may overlap.

The transition between zones may be any type of transition. For example, the transition may be a sudden or immediate transition between zones. In some examples, the transition may be smooth or gradual. In some examples, the transition may include a physical separator between different zones.

As discussed herein, asymmetry of the bearing may be curated to generate a non-rotating net radial force in a particular direction with a particular magnitude based on operating conditions of the bearing. In some embodiments, a single structure may include multiple bearings. For example, an ESP may include multiple bearings, each of which may include a bias to reduce oil whirl and thereby reduce overall vibration of the ESP. In some embodiments, the bias of bearings may be deliberately distributed around the axis to stabilize the rotor assembly and minimize displacement in all planes. In some embodiments, the bias of the bearings may be oriented randomly to account for statistical variations in oil whirl, installation, and vibration. This may facilitate a reduced cost in a component having a multitude of bearings. In some embodiments, the bias of bearings may be deliberately oriented to one or more sides to provide greater hydrodynamic support in the direction of a predictable side load, particularly in hydrodynamic bearings. This may facilitate improved support in generally horizontal installations where the weight of the rotor assembly is the primary load. In some embodiments, the biases of the different bearings may be deliberately oriented or distributed to shift, eliminate and/or modify the vibrational frequency response of the ESP system.

In accordance with at least one embodiment of the present disclosure, the bearings discussed herein may be pressurized with an external pressure source. For example, the bearings may include a hydrostatic bearing pressurizing the bearing may enhance the non-rotating net radial force. The pressure source may be any pressure source. For example, the pressure source may be a stage of the ESP from which pressure is diverted to the bearing. In some examples, the pressure source may be a conduit in a rotating part having another function, such as a radial hole in a thrust bearing runner that acts as a centrifugal pump or a skewed hole that acts as a screw pump. In some examples, the pressure source may be a helical recess in an ESP rotating part such as a shaft or in a stationary bearing, a surrounding part such as a shaft tube that acts as a screw pump. In some examples, the pressure source may be a pump such as a gear or centrifugal pump separate from other components of the ESP, driven mechanically or electrically by parasitic coupling to the ESP.

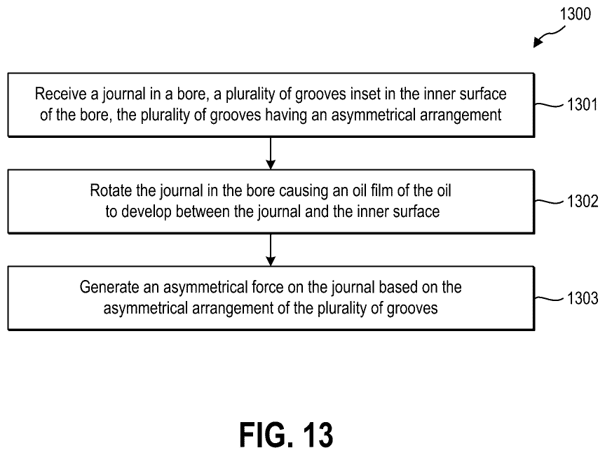

FIG. 13 is a flowchart of a method 1300 for operating a bearing, according to at least one embodiment of the present disclosure. A bearing may receive a journal in a bore of the bearing at 1301. The bore is defined by an inner surface of a body of the bearing. The inner surface may be coated with a low-friction coating. A plurality of recesses may be inset in the inner surface. The plurality of recesses may have an asymmetrical arrangement. The bore includes oil between the journal and the inner surface.

During operation, the journal is rotated in the bore, thereby causing an oil film of the oil to develop between the journal and the inner surface of the bearing at 1302. The bearing may generate an asymmetrical force on the journal based on the asymmetrical arrangement of the plurality of recesses at 1302.

The embodiments of the bearings having asymmetrical recesses, including grooves, dimples, and holes, have been primarily described with reference to wellbore drilling operations; the bearings having asymmetrical recesses described herein may be used in applications other than the drilling of a wellbore. In other embodiments, bearings having asymmetrical recesses according to the present disclosure may be used outside a wellbore or other downhole environment used for the exploration or production of natural resources. For instance, bearings having asymmetrical recesses of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A bearing supporting rotation of a journal, the bearing comprising:
a body defining a bore having an inner surface, the inner surface including a bearing surface; and
a plurality of recesses inset in the inner surface, wherein the plurality of recesses is asymmetrical, the plurality of recesses configured to generate a non-rotating net radial force on the journal.

2. The bearing of claim 1, wherein the plurality of recesses is asymmetrically circumferentially spaced about the inner surface.

3. The bearing of claim 1, wherein the plurality of recesses is asymmetrical along a length of the bearing.

4. The bearing of claim 1, wherein the plurality of recesses is asymmetrical in size.

5. The bearing of claim 1, wherein the plurality of recesses include a plurality of recess groups, a first recess group of the plurality of recess groups different than a second recess groups of the plurality of recess groups.

6. The bearing of claim 1, wherein the plurality of recesses is asymmetrical in shape.

7. The bearing of claim 1, wherein the plurality of recesses is asymmetrical in depth along a length of the bearing.

8. The bearing of claim 1, wherein the plurality of recesses each has a leading edge, a first leading edge of a first recess of the plurality of recesses contoured with first shape, a second leading edge of a second recess of the plurality of recesses contoured with a second shape, the first shape different than the second shape.

9. The bearing of claim 1, wherein the plurality of recesses include a plurality of dimples.

10. The bearing of claim 1, wherein the body forms a conduit connecting a first recess of the plurality of recesses to a second recess of the plurality of recesses, the conduit opening at the first recess of the plurality of recesses and the second recess of the plurality of recesses.

11. The bearing of claim 10, wherein the first recess of the plurality of recesses is separated from the second recess of the plurality of recesses with a third recess of the plurality of recesses.

12. A bearing system, comprising:
a body defining a bore having an inner surface;
a plurality of recesses inset in the inner surface, wherein the plurality of recesses has an asymmetrical arrangement;
a journal inserted in the bore and configured to rotate in the bore; and
fluid between the journal and the body, wherein the plurality of recesses apply a force on the journal based on the asymmetrical arrangement.

13. The bearing system of claim 12, wherein the bearing system includes a hydrostatic bearing, and further comprising a pressure source external to the body.

14. The bearing system of claim 13, wherein the pressure source includes a pump.

15. The bearing system of claim 13, wherein the pressure source includes a component of an electric submersible pump.

16. A method for operating a bearing, the method comprising:
receiving a journal in a bore, the bore defined by an inner surface of a body, the inner surface including a bearing surface, an asymmetrical geometry, the bore including fluid between the journal and the inner surface;
rotating the journal in the bore causing fluid film of the fluid to develop between the journal and the inner surface; and
generating a non-rotating net radial force on the journal based on the asymmetrical geometry.

17. The method of claim 16, wherein the bearing includes a hydrodynamic bearing, and further comprising flowing a portion of the fluid out of the bearing through at least one of a plurality of recesses based on the asymmetrical geometry.

18. The method of claim 16, wherein the bearing includes a hydrodynamic bearing, and further comprising directing the fluid to a region of the inner surface, the region based on the asymmetrical geometry.

19. The method of claim 16, wherein the non-rotating net radial force causes a first fluid film thickness opposite the non-rotating net radial force to be less than a second fluid film thickness adjacent the non-rotating net radial force.

20. The method of claim 16, wherein the asymmetrical geometry includes non-perpendicular contours of ends of the bore, producing a net non-rotating hydrodynamic force on the journal.
